(19) United States
(12) Patent Application Publication
(10) Pub. No.: US 2006/0056664 A1
(43) Pub. Date: Mar. 16, 2006

(54) Security system

(75) Inventor: Taiji Iwasaki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/225,040

(22) Filed: Sep. 14, 2005

(30) Foreign Application Priority Data
Sep. 14, 2004 (JP) 267047/2004
Aug. 29, 2005 (JP) 247682/2005

(51) Int. Cl. G06K 9/00

(52) U.S. Cl. 382/115

(57) ABSTRACT

During use of equipment by a user having qualifications to use the equipment, an image of the user is continuously photographed by a video camera. When the face of the user can no longer be detected from the image acquired by the camera, warning is issued through voice and screen display and the photographing of an image and the detection of a face are continued. When the face of the user cannot be detected within a predetermined amount of time (e.g., 10 seconds), the equipment is locked.

### BACKGROUND OF THE INVENTION

1. Field of the Invention

The present invention relates generally to security systems, and more particularly to security systems that permit only a qualified user to use equipment and are able to prevent the qualified user from inadvertently being forbidden to use the equipment.

2. Description of the Related Art

Systems for performing authentication by the use of biometric information such as a fingerprint, a vein, an iris, a facial image, etc., of a user and permitting only an authenticated user to use equipment are utilized in various fields. For example, in using a personal computer (PC), there is utilized a system for acquiring the biometric information of a user, checking the acquired biometric information against the biometric information of a qualified user registered beforehand in a database, and permitting use of the PC when the two match with each other as a result of checking. Similarly, in mobile equipment such as a mobile telephone, there is utilized a system for performing the aforementioned authentication and permitting an authenticated user to use that mobile equipment.

Most of these systems perform authentication only at the start of use. That is, once authentication is successful, it is not performed until use of the equipment concludes. Because of this, when a user having qualifications to use a PC leaves her seat during use, or when a qualified user is deprived of her mobile equipment by another person during use, even an unqualified person is able to use the PC or equipment without authorization and thus there is a problem that security will be compromised.

Japanese Unexamined Patent Publication No. 2003-058269 proposes a system for solving the problem of security associated with mobile equipment. The system disclosed in Japanese Unexamined Patent Publication No. 2003-058269 detects the heartbeat, pulse, features, etc., of a user with a sensor and permits a qualified user to use mobile equipment, then continuously monitors whether or not the user is continuously using the mobile equipment, and forbids the use of the mobile equipment if it is detected that the user is not continuously using the mobile equipment. Such a system can prevent unauthorized use of equipment even in the aforementioned case where a user leaves her seat or is deprived of her mobile equipment by another person, and thus security can be enhanced compared with the aforementioned security systems.

However, the system disclosed in the aforementioned Japanese Unexamined Patent Publication No. 2003-058269 is designed to forbid the use of mobile equipment immediately, if it detects that a qualified user is not continuously using the mobile equipment. For instance, when a facial image of a user is continuously acquired and the user is not continuously using mobile equipment (i.e., when a facial image cannot be acquired), the mobile equipment is locked immediately. Due to this, when a user bends his or her head to search for something during use or turns his or her face transversely to talk with a neighbor, the facial image of the user cannot be obtained temporarily and therefore the equipment is locked. If the user is to use the equipment again, the authentication procedure of unlocking the equipment must be performed and causes inconvenience.

### SUMMARY OF THE INVENTION

The present invention has been made in view of the circumstances mentioned above. Accordingly, it is the object of the present invention to provide a security system that is capable of ensuring security and preventing the use of equipment from inadvertently being forbidden.

To achieve this end, there is provided a security system in accordance with the present invention. The security system comprises four major components: (1) biometric information acquisition means that, as equipment is used by a user having qualifications to use the equipment, continuously acquires biometric information of the user; (2) check means for continuously checking the biometric information against previously registered biometric information of the user; (3) control means for forbidding continuous use of the equipment when the checking fails; and (4) warning means for issuing a warning to the user when the acquisition of the biometric information of the user by the biometric information acquisition means fails. The aforementioned biometric information acquisition means continues to acquire the biometric information of the user even after the failure of the acquisition of the biometric information of the user, and the aforementioned control means forbids use of the equipment when the biometric information acquisition means cannot acquire the biometric information of the user within a predetermined amount of time from the failure of the acquisition of the biometric information.

In the security system of the present invention, the “previously registered” biometric information of the user may be biometric information of a qualified user registered beforehand in a database before the aforementioned checking is performed. For example, in systems where biometric information of a qualified user is read out from an IC card and is checked with biometric information acquired by biometric information acquisition means, the biometric information read out from the IC card corresponds to the “previously registered biometric information” employed in the present invention.

The aforementioned warning means may issue the aforementioned warning aurally, and/or visually, and/or tactually. Issuing the warning aurally means that an electronically generated audio warning signal is given to the user. Examples are a warning sound through a speaker, a warning announcement, etc. Issuing the warning visually means that a visible warning signal is given to the user. Examples are characters displayed on the screen of a PC or mobile telephone, a blinking light, etc. Issuing the warning tactually means that a tactual warning signal is given to the user. An example is vibration by a vibrator.

In the security system of the present invention, the aforementioned warning means preferably notifies the user of the aforementioned predetermined amount of time before use of the equipment is forbidden. For instance, in the case of an audible warning means, it is preferable to issue a warning, such as “the computer will be locked in ◯◯ seconds”.

In the security system of the present invention, the aforementioned biometric information may be any type of biometric information, which can be employed in authentication, such as a fingerprint, a vein, an iris, etc. However, considering the ease of the acquisition of information and the installation of the biometric information acquisition means, it is preferable to employ a facial image of a user. In this case, the aforementioned biometric information acquisition means comprises image photographing means.

In the security system of the present invention, the aforementioned biometric information acquisition means may comprise image photographing means and at least one of among fingerprint reading means, vein reading means, and iris reading means.

Before the failure of the acquisition of the aforementioned biometric information, the biometric information may be the facial image of the user photographed by the photographing means. Between the acquisition failure and the aforementioned predetermined amount of time, the biometric information may be at least one of among the fingerprint information, vein information, and iris information of the aforementioned user respectively read by the aforementioned fingerprint reading means, vein reading means, and iris reading means.

In the security system of the present invention, the aforementioned control means may be constructed such that, when forbidding use of the aforementioned equipment, the aforementioned predetermined amount of time in subsequent use of the equipment is prolonged or shortened.

In the security system of the present invention, biometric information of a user having qualifications to use equipment is continuously acquired, as the user uses the equipment. The acquired biometric information is continuously checked against previously registered biometric information of the user. When the checking fails, continuous use of the equipment is forbidden. In the security system of the present invention, however, when the acquisition of the biometric information of the user by the biometric information acquisition means fails, use of the equipment is not forbidden immediately. That is, the aforementioned biometric information acquisition means continues to acquire the biometric information of the user even after the failure of the acquisition of the biometric information of the user. And when the biometric information acquisition means cannot acquire the biometric information of the user within a predetermined amount of time, use of the equipment is forbidden. By doing so, in the case of employing a facial image of the user as biometric information, even when the face of the qualified user cannot be detected temporarily during use of the computer due to the user bending her head to search for something or turning her face transversely to talk with a neighbor, the use of equipment can be prevented from inadvertently being forbidden, if the user returns her face to a detectable position within a predetermined amount of time. In addition, the procedure of unlocking the equipment can be avoided. Thus, the security system of this embodiment can ensure security and is convenient for use. Furthermore, when the acquisition of the biometric information fails, the warning is issued. Therefore, even if the user was completely wrapped up in something else, the warning can be issued so that the user is urged to return her face to a detectable position.

### BRIEF DESCRIPTION OF THE DRAWINGS

The present invention will be described in further detail with reference to the accompanying drawings wherein:

FIG. 1 is a block diagram showing a computer that forms a preferred embodiment of a security system of the present invention;

FIG. 2 is a block diagram showing the construction of an authentication section provided in the computer shown in FIG. 1;

FIG. 3 is a block diagram showing the construction of a face detection section provided in the authentication section shown in FIG. 2;

FIG. 4, which includes FIGS. 4A and 4B, is a diagram used to explain the central position of an eye;

FIG. 5A is a diagram showing a horizontal edge detection filter;

FIG. 5B is a diagram showing a vertical edge detection filter;

FIG. 6 is a diagram used to explain the calculation of a gradient vector;

FIG. 7A is a diagram showing the face of a person;

FIG. 7B is a diagram showing gradient vectors near to the eyes and noise of the face shown in FIG. 7A;

FIG. 8A is a diagram showing a histogram for the magnitudes of gradient vectors before normalization;

FIG. 8B is a diagram showing a histogram obtained by normalizing the gradient vector magnitudes shown in FIG. 8A;

FIG. 8C is a diagram showing a histogram for the magnitudes of gradient vectors divided into five intervals;

FIG. 8D is a diagram showing a histogram obtained by normalizing the gradient vector magnitudes shown in FIG. 8C;

FIG. 9 is a diagram showing examples of sample images known to be faces that are employed in learning first reference data;

FIG. 10 is a diagram showing examples of sample images known to be faces that are employed in learning second reference data;

FIG. 11, which includes FIGS. 11A through 1C, is a diagram used to explain the rotation of a face;

FIG. 12 is a flowchart showing how the learning of reference data is performed;

FIG. 13 is a diagram used to explain a method of generating an identifier;

FIG. 14 is a diagram used to explain how an image to be identified varies in stages;

FIG. 15 is a flowchart showing the essential steps performed by the face detection section shown in FIG. 1;

FIG. 16 is a diagram showing the construction of the warning section provided in the computer shown in FIG. 1;

FIG. 17 is a flowchart showing how the computer of the embodiment shown in FIG. 1 is to be operated; and

FIG. 18 is a flowchart showing how the computer of the embodiment shown in FIG. 1 is to be operated.

### DESCRIPTION OF THE PREFERRED EMBODIMENTS

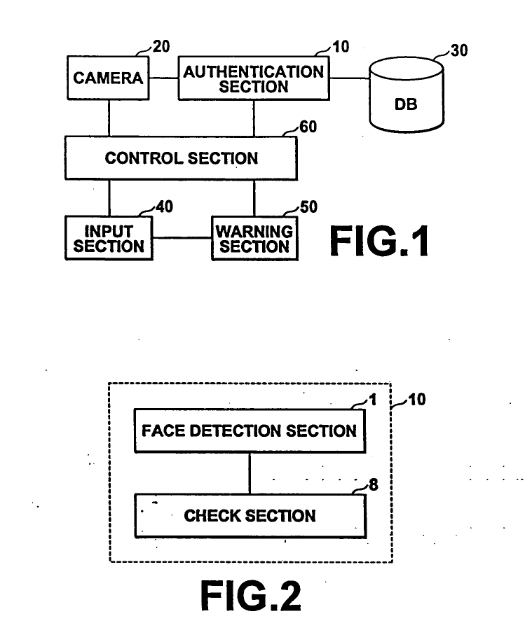

FIG. 1 shows a computer forming a preferred embodiment of a security system of the present invention. Note that for the purpose of clarity in description of the present invention, only the components relating to the security system of the present invention will be described, and descriptions and illustrations of other basic computer components will not be given. The computer of this embodiment realizes the security system of the present invention in cooperation with programs stored in an auxiliary storage, hardware (a CPU, etc.), and software (an operating system (OS), etc.).

As shown in the figure, the computer of this embodiment comprises six major components: (1) a video camera 20 for continuously photographing an image of a user present in front of the computer at the time of log-in and during use; (2) a database (DB) 30 in which a facial image of a user having qualifications to use the computer is stored; (3) an authentication section 10 for performing authentication by checking the image acquired by the video camera 20 against the facial image stored in the DB 30, at the time of log-in and during use; (4) an input section 40 through which the user performs various inputs; (5) a warning section 50 for issuing a warning through voice or sound and screen display; and (6) a control section 60 for controlling each of the aforementioned components.

The input section 40 is a section for a user to input various input signals such as an input signal for log-in, input signals after log-in, an input signal for log-out, etc.

The DB 30 stores a facial image of a user having qualifications to use the computer (hereinafter referred to as a registered image). The registered image may be one in which no process is performed on a facial image obtained at the time of registration, but it is preferable to perform a modeling process for authentication, such as a characteristic-quantity extracting process and a wire-frame modeling process, on the facial image obtained by photographing an image of a user. When no modeling process is performed on the registered image, the authentication section 10 may perform authentication by employing a registered image and a raw image, as they are. However, to enhance accuracy of authentication, it is preferable to perform checking after the modeling process is performed on both a registered image and a raw image. In this embodiment, to enhance accuracy of checking and shorten processing time, the DB 30 stores registered images on which the modeling process was performed, and the authentication section 10 performs the modeling process on a facial image (hereinafter referred to as a raw image) acquired by the video camera 20 and then employs the processed image in performing authentication.

The video camera 20 continuously photographs an image of a user present in front of the computer in the form of a motion picture, at the time of log-in and during the time from log-in to log-out (or forced conclusion of use of the computer) and provides the authentication section 10 with the photographed image.

Note that the biometric information for registration, in addition to the facial image or instead of the facial image, is also able to employ fingerprint information, vein information, iris information, and so forth. In this case, a fingerprint reader, a vein reader, an iris reader, etc., are prepared and the biometric information read by these readers is transferred to the authentication section 10.

The authentication section 10 performs authentication by checking a raw image acquired by the video camera 20 against a registered image stored in the DB 30. The construction of the authentication section 10 is shown in FIG. 2. As shown in the figure, the authentication section 10 comprises a face detection section 1 for detecting a face from a raw image acquired by the video camera 20, and a check section 8 for checking the image of the facial portion detected by the face detection section 1 against a registered image stored in the DB 30. The registered image stored in the DB 30 has undergone the modeling process for checking, so the check section 8 performs the same modeling process on the image of the facial portion of the raw image and then performs checking. However, in the following description, it is simply stated that checking is performed by employing the image of the facial portion and the registered image.

FIG. 3 shows the construction of the face detection section 1 of the authentication section 10 shown in FIG. 2. The face detection section 1 is used to detect a face from an image frame (hereinafter referred to as a photographic image S0) cut out from a motion image obtained by the video camera 20. As shown in the figure, the face detection section 1 comprises five major components: (1) a characteristic quantity calculation section 2 for calculating a characteristic quantity C0 from the photographic image S0; (2) a second storage section 4 for storing first and second reference data E1, E2; (3) a first identification section 5 for identifying, based on the characteristic quantity C0 calculated by the characteristic quantity calculation section 2 and on the first reference data E1 stored in the second storage section 4, whether the face of a person is included in the photographic image S0; (4) a second identification section 6 that, when it is identified by the first identification section 5 that a face is included in the photographic image S0, identifies the position of an eye included in that face, on the basis of the characteristic quantity C0 calculated by the characteristic quantity calculation section 2 and of the second reference data E2 stored in the second storage section 4; and (5) a first output section 7.

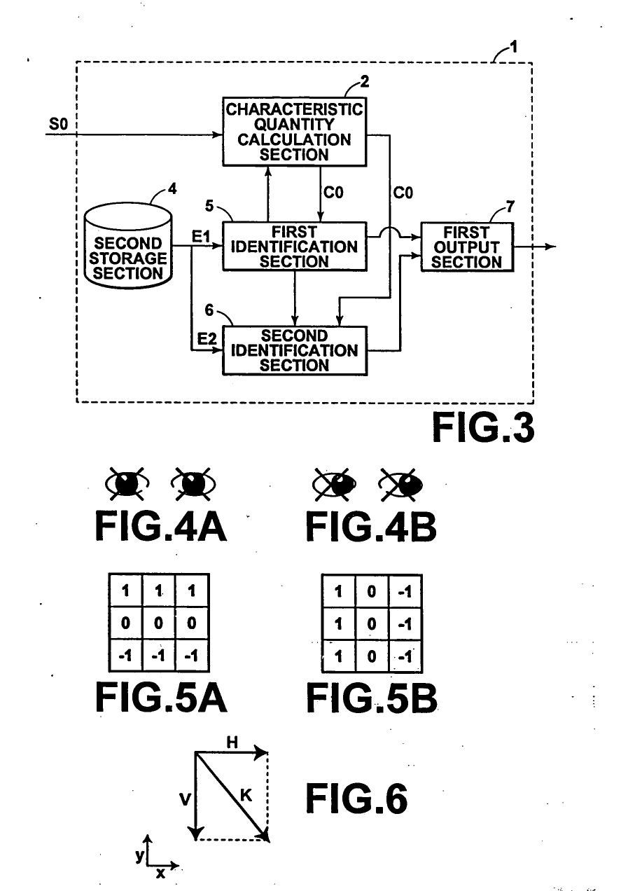

The position of an eye to be identified by the face detection section 1 is the central position between the inside and outside corners of the eye. As shown in FIG. 4A, when a user looks straight ahead, the central position of the eye is the same as the central position of the pupil. As shown in FIG. 4B, when a user looks to the right, the central position of the eye is shifted from the central position of the pupil or is in the white eye portion.

The characteristic quantity calculation section 2 calculates from the photographic image S0 a characteristic quantity C that is used in identifying a face. When it is identified that a face is included in the photographic image S0, the characteristic quantity calculation section 2 calculates a characteristic quantity C0 from an image of a face extracted as described later. More particularly, a gradient vector (i.e., the direction in which the photographic density at each pixel on the photographic image S0 and on the facial image changes, and the magnitude of the change) is calculated as a characteristic quantity C0. The calculation of the gradient vector will hereinafter be described. Initially, the characteristic quantity calculation section 2 performs a horizontal filtering process on the photographic image S0 by use of a horizontal edge detection filter shown in FIG. 5A and detects a horizontal edge in the photographic image S0. Likewise, the characteristic quantity calculation section 2 performs a vertical filtering process on the photographic image S0 by use of a vertical edge detection filter shown in FIG. 5B and detects a vertical edge in the photographic image S0. And from the magnitude H of the horizontal edge and magnitude V of the vertical edge at each pixel on the photographic image S0, the gradient vector K at each pixel is calculated as shown in FIG. 6. For a facial image extracted from the photographic image S0, the gradient vector K is similarly calculated. Note that the characteristic quantity calculation section 2 calculates a characteristic quantity C0 at each of the stages of variations of the photographic image S0 and facial image, as described later.

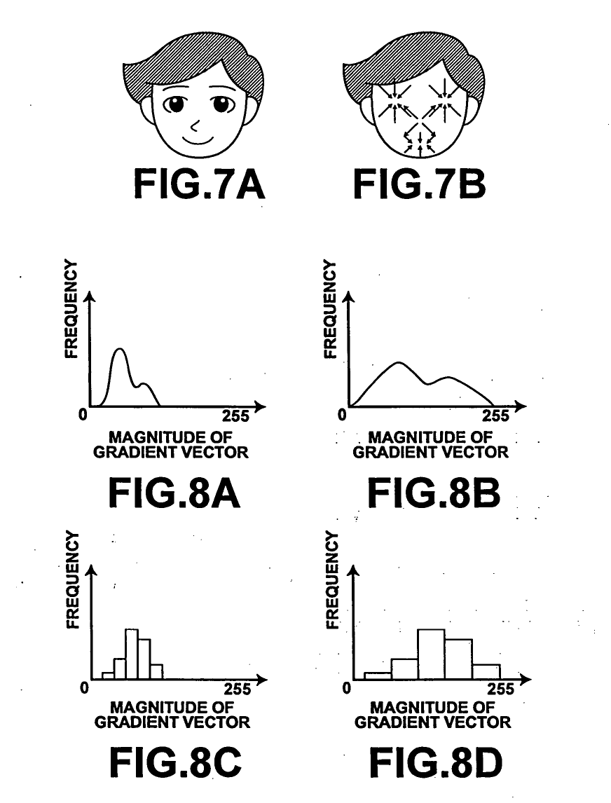

In the case of the face of a person such as that shown in FIG. 7A, at dark portions (such as the eyes and the mouth) the calculated gradient vectors K are directed toward their centers, as shown in FIG. 7B. At light portions such as the nose, the calculated gradient vectors K are directed outside from the position of the nose. In addition, a change in the photographic density of the eye is greater than that of the mouth, so the gradient vectors K for the eye are greater in magnitude than those for the mouth.

The direction and magnitude of the aforementioned gradient vector K are referred to as the characteristic quantity C0. The direction of the gradient vector K has a value in the range of 0 to 359°, with a predetermined direction (e.g., the x direction in FIG. 6) as reference.

The magnitude of the gradient vector K is normalized. This normalization is performed by calculating a histogram for the magnitudes of gradient vectors K at all pixels of the photographic image S0, and smoothing the histogram so that the magnitudes are evenly distributed to values (e.g., 0 to 255 for 8 bits) that each pixel of the photographic image S0 can have and thereby correcting the magnitudes of the gradient vectors K. For example, in the case of a histogram in which many of the magnitudes of the gradient vectors K are on the smaller side, as shown in FIG. 8A, the histogram is smoothed as shown in FIG. 8B by normalizing the magnitudes of the gradient vectors K so that they are distributed over the entire range of 0 to 255. To reduce the amount of calculation, as shown in FIG. 8C, it is preferable to divide the range of distribution in the histogram for gradient vectors K, for example, into five parts and perform normalization so that the five parts are distributed over the entire range of 0 to 225.

The first and second reference data E1 and E2, stored in the second storage section 4, prescribe identifying conditions for combinations of characteristic quantities C0 at pixels constituting each pixel group, with respect to a plurality of kinds of pixel groups consisting of a combination of pixels selected from a sample image to be described later.

The combinations of characteristic quantities C0 at pixels constituting each pixel group and the identifying conditions, prescribed by the first and second reference data E1 and E2, are determined beforehand by the learning of a sample image group consisting of first sample images known to be faces and second sample images known not to be faces.

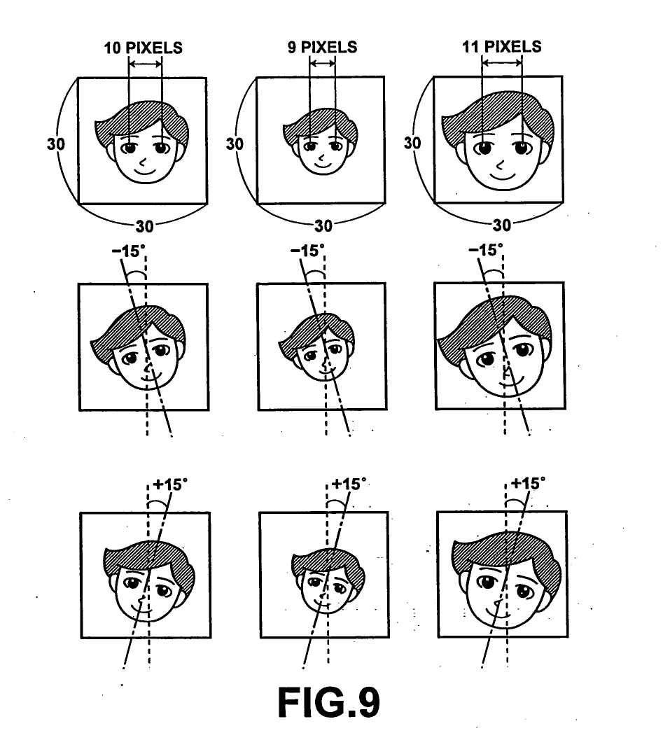

In this embodiment, in generating the first reference data E1, a sample image known to be a face has a size of 30×30 pixels. As shown in the top portion of FIG. 9, in the three images of one face, the distances between the centers of both eyes are 10 pixels, 9 pixels, and 11 pixels. Each of the three images standing vertically with respect to the intercentral distance of both eyes is rotated at intervals of 3° in the range of ±15°. That is, each image is rotated at angles of −15°, −12°, −9°, −6°, −3°, 0°, 3°, 6°, 9°, 12°, and 15°. Therefore, for one face, 3×11 sample images (33 sample images) are prepared. Note in FIG. 9 that only sample images rotated at angles of −15°, 0°, and +15° are shown. The center of rotation is the point of intersection between the diagonals of each sample image. For example, in the sample images where the distance between the centers of both eyes is 10 pixels, the central positions of the eyes are the same. In the coordinate system where the upper left corner of each sample image is the origin, the central positions of these eyes are represented as (x1, y1) and (x2, y2). The positions of the eyes in the vertical direction (i.e., x1, x2) are the same in all sample images.

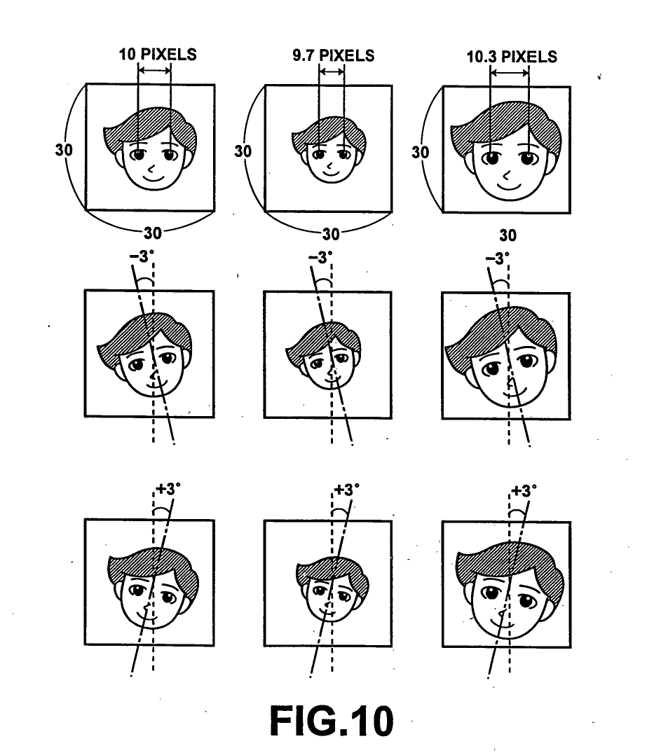

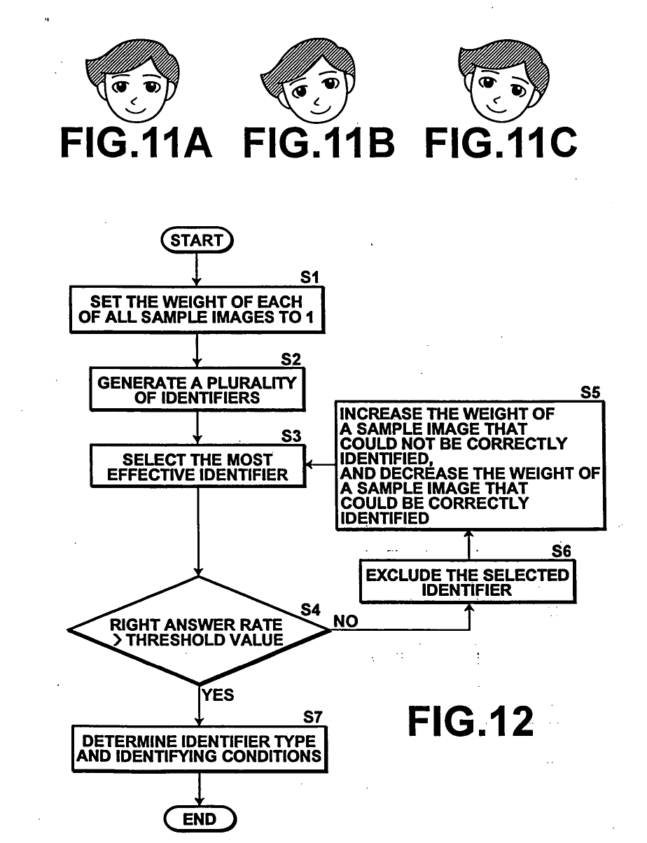

In generating the second reference data E2, a sample image known to be a face has a size of 30×30 pixels. As shown in the top portion of FIG. 10, in the three images of one face, the distances between the centers of both eyes are 10 pixels, 9.7 pixels, and 10.3 pixels. Each of the three images standing vertically with respect to the intercentral distance of both eyes is rotated at intervals of 1° in the range of ±3°. That is, each image is rotated at angles of −3, −2°, 0°, 1°, 2°, and 3°. Therefore, for one face, 3×7 sample images (21 sample images) are prepared. Note in FIG. 10 that only sample images rotated at angles of −3°, 0°, and +3° are shown. The center of rotation is the point of intersection between the diagonals of each sample image. The positions of the eyes in the vertical direction are the same in all sample images. The sample image in which the distance between the centers of both eyes is 9.7 pixels can be obtained by reducing to 9.7/10 of the sample image in which the distance between the centers of both eyes is 10 pixels, and making the pixel size of the reduced sample image equal to 30×30 pixels. Similarly, the sample image in which the distance between the centers of both eyes is 10.3 pixels can be obtained by enlarging to 10.3/10 of the sample image in which the distance between the centers of both eyes is 10 pixels, and making the pixel size of the enlarged sample image equal to 30×30 pixels.

The central position of the eye in the sample image employed in the learning of the second reference data E2 is the position of an eye to be identified in this embodiment.

Sample images known not to be faces have a size of 30×30 pixels and employ arbitrary images.

If learning is performed by employing only the sample image, known to be a face, in which the intercentral distance of the eyes is 10 pixels and in which the angle of rotation is 0°, a face or the position of an eye that is to be identified by referring to the first and second reference data E1 and E2 is only a face in which the intercentral distance of both eyes is 10 pixels and in which the angle of rotation is 0°. Faces having the possibility of being included in the photographic image S vary in size. Therefore, in identifying whether a face is included, or in identifying the position of an eye, the photographic image S0 is enlarged or reduced as described later. In this manner, faces of sizes that correspond to sizes of sample images, and the position of an eye, can be identified. However, if the intercentral distance of both eyes is to be made equal to 10 pixels exactly, identification must be performed while enlarging or reducing the size of the photographic image S0 at intervals of a ratio of 1/10. As a result, the amount of calculation will be enormous.

In addition, faces having the possibility of being included in the photographic image S0 include not only a face whose angle of rotation is 0 (e.g., a non-rotated face shown in FIG. 1C) but also faces whose angle of rotation is not 0° (e.g., rotated faces shown in FIGS. 11B and 11C). However, if learning is performed using only the sample image in which the intercentral distance of both eyes is 10 pixels and in which the angle of rotation is 0°, rotated faces such as those shown in FIGS. 11B and 11C cannot be identified, although they are faces.

Because of this, in this embodiment, as shown in FIG. 9, sample images, in which the intercentral distances of both eyes are 9 pixels, 10 pixels and 11 pixels and which are rotated at intervals of 3° in the range of ±15°, are employed as sample images known to be faces. As a result, in the learning of the first reference data E1, there is a degree of allowance. Therefore, in performing identification by the first identifying section 5 described later, the photographic image S0 is enlarged or reduced at intervals of a ratio of 11/9. As a result, the processing time can be reduced compared with the case where the photographic image S0 is enlarged or reduced at intervals of a ratio of 0.1. In addition, rotated faces such as those shown in FIGS. 11B and 11C can be identified.

On the other hand, the learning of the second reference data E2 employs sample images in which the intercentral distances of both eyes are 9.7 pixels, 10 pixels, and 10.3 pixels and in which the face is rotated at intervals of 10 in the range of ±3°, as shown in FIG. 10. Because of this, a degree of allowance for the learning of the second reference data E2 is small compared with that of the first reference data E1. In performing identification by the second identifying section 6 described later, the photographic image S0 has to be enlarged or reduced at intervals of a ratio of 10.3/9.7, so the processing time is long compared with the identification performed by the first identifying section 5. However, the second identifying section 6 identifies only the images within a face identified by the first identifying section 5, so that the amount of calculation for identifying the position of an eye can be reduced compared with the case of employing the entire photographic image S0.

An example of a method to learn a sample image group will hereinafter be described with reference to FIG. 12. In the figure, the learning of the first reference data E1 will be described.

A sample image group employed in learning consists of sample images known to be faces and sample images known not to be faces. As set forth above, the sample images known to be faces employ images in which the intercentral distance of both eyes are 9, 10, and 11 pixels and which are rotated at intervals of 3° in the range of ±15°. Each sample image is assigned weight, i.e., importance. First, all sample images are set so that they have a weight of 1 (S1).

Then, for a plurality of kinds of pixel groups in the sample image group, identifiers are generated (S2). The respective identifiers provide references for identifying a facial image and an image other than a face, using combinations of characteristic quantities C0 at pixels constituting one pixel group. In this embodiment, a histogram for combinations of characteristic quantities C0 at pixels constituting one pixel group is used as an identifier.

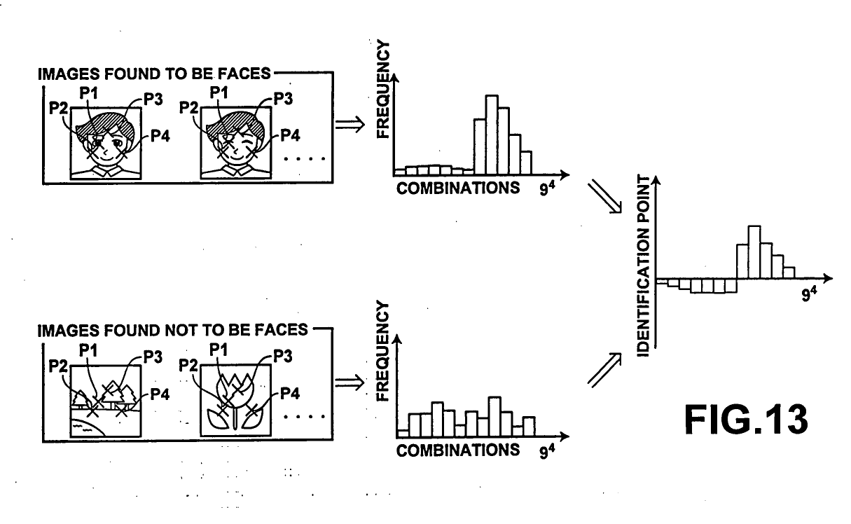

The generation of an identifier will be described with reference to FIG. 13. As shown in the sample images on the left portion of the figure, the pixels of a pixel group for generating this identifier are a first pixel P1 at the center of the right eye, a second pixel P2 at the right cheek, a third pixel P3 at the forehead, and a fourth pixel P4 at the left cheek, which are on each of the sample images known to be faces. A combination of characteristic quantities C0 at all pixels P1 to P4 is obtained for each of the sample images known to be faces, and a histogram for the combinations is generated. The characteristic quantity C0 represents the direction and magnitude of a gradient vector K, as set forth above. In gradient vectors K, there are 360 different directions from 0 to 359 and 256 different magnitudes from 0 to 255. Therefore, if gradient vectors K are employed as they are, the number of combinations is (360×256)⁴ for 4 pixels and a huge number of samples, time, and memory are required for learning and detection. Because of this, in this embodiment, the directions of gradient vectors K are classified into 4 values: to 44 and 315 to 359 (0 for the right direction); 45 to 134 (1 for the up direction); 135 to 224 (2 for the left direction); and 225 to 314 (3 for the down direction), while the magnitudes are classified into three values (0 to 2). The value of each combination is calculated using the following equation:
Value of a combination=0 (when the magnitude of a gradient vector is 0); and
Value of a combination=(direction of gradient vector+1)×magnitude of gradient vector (when the magnitude of a gradient vector>0).

This reduces the number of combinations to 9⁴, so the number of data for the characteristic quantities C0 can be reduced.

Similarly, a histogram is generated for a plurality of sample images known not to be faces. Note that the sample images known not to be faces employ the pixels that correspond to the positions of the aforementioned pixels P1 to P4 on the sample image known to be a face. A histogram obtained by calculating the logarithm of the ratio of the numbers of combinations represented by the two histograms is shown in the right portion of FIG. 13 and is employed as an identifier. The values on the vertical axis of the histogram for the identifier will hereinafter be referred to as identification points. According to this identifier, it can be said that an image representing a distribution of characteristic quantities C0 corresponding to positive identification points has a great possibility of being a face and that a greater absolute value of an identification point increases the possibility. Conversely, an image representing a distribution of characteristic quantities C0 corresponding to negative identification points has a great possibility of not being a face, and a greater absolute value of an identification point increases the possibility. In step S2, for combinations of characteristic quantities C0 at the pixels of a plurality of kinds of pixel groups that are used in identification, a plurality of identifiers in the form of a histogram are generated.

Subsequently, among the identifiers generated in step S2, the identifier most effective to identify whether an image is a face is selected. The selection of the most effective identifier is performed, considering the weight of each sample image. In this example, the weighted right answer rates of the identifiers are compared with one another and the identifier showing the highest weighted right answer rate is selected (S3). That is, in step S3 in the first round, the weight of each of the sample images is 1, so the identifier, having the largest number of sample images with which an image is identified rightly as a face, is simply selected as the most effective identifier. On the other hand, in step S3 in the second round after the weight of each of the sample images is updated in step S5 described later, sample images with a weight of 1, sample images with a weight greater than 1, and sample images with a weight less than 1 are present together. The sample image having a weight greater than 1 has a higher count in the evaluation of a right answer rate than that of the sample image having a weight of 1. Because of this, in steps S3 in the second round and subsequent rounds, sample images whose weight is greater are identified more rightly than sample images whose weight is smaller.

Next, it is ascertained whether the right answer rate by the combination of the hitherto selected identifiers (i.e., the rate at which the result of the identification, using the combination of the hitherto selected identifiers, of whether each sample image is a face coincides with an actual answer of whether each sample image is a face) has exceeded a predetermined threshold value (S4). What is employed in the evaluation of the right answer rate of a combination of identifiers may be a sample image group assigned the present weight, or a sample image group in which the weight of each sample image is the same. When it exceeds the predetermined threshold value, whether an image is a face can be identified at a sufficiently high probability, if the hitherto selected identifiers are employed. Therefore, the learning process ends here. When it is less than the predetermined threshold value, the learning process advances to step S6 in order to select an additional identifier that is employed in combination with the hitherto selected identifiers.

In step S6, the identifiers selected in the previous step S3 are excluded so that they are not selected again.

Next, the weight of the sample image that could not rightly identify whether an image is a face by the identifier selected in the previous step S3 is made greater and the weight of the sample image that could rightly identify whether an image is a face is made smaller (S5). The reason why the weight is made greater or smaller is that in the selection of the next identifier, images that could not be rightly identified by the already selected identifiers are considered important so that an identifier capable of rightly identifying whether these images are faces is selected. In this manner, the effect of a combination of identifiers is enhanced.

Subsequently, the learning process returns to step S3, in which, as described above, the secondly effective identifier is selected with the weighted right answer rate as reference.

When, by repeating the aforementioned steps S3 to S6, an identifier corresponding to combinations of characteristic quantities C0 at the pixels of a specific pixel group is selected as an identifier suitable for identifying whether a face is included, the identifier type for identifying whether a face is included and the identifying conditions are determined, if the right answer rate in step S4 exceeds the predetermined threshold value (S7). At this stage, the learning of the first reference data E1 ends.

By determining identifier type and identifying conditions in the aforementioned manner, the learning of the second reference data E2 is performed.

In the case of adopting the aforementioned learning method, identifiers are not limited to the form of a histogram, if they provide references for identifying a facial image and an image other than a face by the use of combinations of characteristic quantities C0 obtained at the pixels of a specific pixel group. For instance, they may be binary data, a threshold value, a function, etc. The aforementioned histogram may be a histogram showing a distribution of differences between two histograms shown in the central portion of FIG. 13.

The learning method is not limited to the aforementioned method, but may employ other machine running methods such as a neutral network.

By referring to the identifying conditions that the first reference data E1 learned for all of the combinations of characteristic quantities C0 obtained at the pixels of a plurality of kinds of pixel groups, the first identifying section 5 calculates identifying points for the combinations of characteristic quantities C0 obtained at the pixels of each of the pixel groups, and identifies whether a face is included in the photographic image S0, considering all of the identifying points. As described above, the direction and magnitude of a gradient vector K, which are the characteristic quantity C0, are represented by any of four values (0, 1, 2, and 3) and any of three values (0, 1, and 2), respectively. This embodiment adds up all of the identifying points and performs identification by the positive or negative of the added value. For example, when the sum total of the identifying points is a positive value, it is judged that a face is included in the photographic image S0. When it is a negative value, it is judged that no face is included in the photographic image S0. The identification of whether a face is included in the photographic image S0, which is performed by the first identifying section 5, is referred to as first identification.

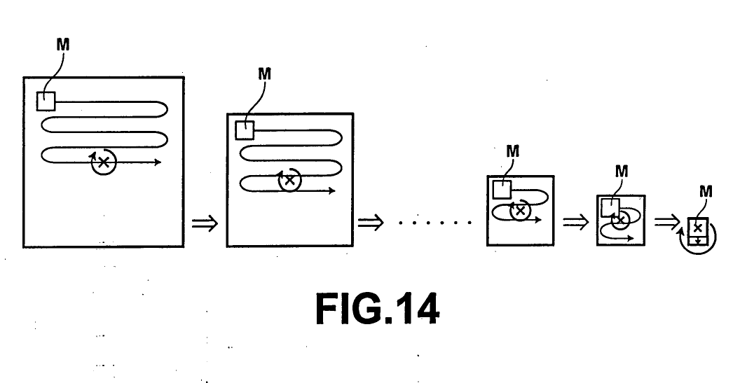

The size of the photographic image S0 is not fixed, unlike sample images having a fixed size of 30×30 pixels. In the case where a face is included, the rotation angle of the face is not always 0°. Due to this, as shown in FIG. 14, by enlarging or reducing the photographic image S0 in stages until the vertical or horizontal size of the photographic image S0 becomes 30 pixels and rotating it 360° in stages on a plane (in FIG. 14 the size of the photographic image S0 is reduced in stages), setting a mask M with a size of 30×30 pixels onto the photographic images S0 enlarged or reduced in stages, moving the mask M on the enlarge or reduced photographic images S0 at intervals of 1 pixel, and identifying whether an image within the mask is an image of a face, the first identifying section 5 identifies whether a face is included in the photographic image S0.

As set forth above, the sample images that were learned at the time of the generation of the first reference data E1 are images in which the intercentral distances of both eyes are 9, 10, and 11 pixels. Therefore, a magnification ratio at the time of the enlargement or reduction of the photographic image S0 is 11/9. The sample images that were learned at the time of the generation of the first reference data E1 are also rotated in the range of ±15° on a plane. Therefore, the photographic image S0 is rotated 360° at intervals of 30°.

Note that the characteristic quantity calculation section 2 calculates a characteristic quantity C0 at each of the stages of variations, such as enlargement/reduction and rotation, of the photographic image S0.

The identification of whether a face is included in the photographic image S0 is performed at all stages of the enlargement/reduction and rotation of the photographic image S0. When it is identified even once that a face is included, it is identified that a face is included in the photographic image S0, and from the photographic image S0 of the size and rotation angle at the stage of that identification, a region of 30×30 pixels corresponding to the position of the identified mask M is extracted as the image of a face.

On the image of a face extracted by the first identifying section 5, by referring to the identifying conditions that the second reference data E2 learned for all of the combinations of the characteristic quantities C0 obtained at the pixels constituting a plurality of kinds of pixel groups, the second identifying section 6 calculates identifying points for the combinations of the characteristic quantities C0, and identifies the positions of the eyes included in the face, considering all of the identifying points. In this identification, the direction and magnitude of a gradient vector K that are a characteristic quantity C are represented by any of 4 values and any of 3 values, respectively.

By enlarging or reducing in stages and rotating 360° in stages the facial image extracted by the first identifying section 5, setting a mask M with a size of 30×30 pixels onto the facial images enlarged or reduced in stages, and moving the mask M at intervals of 1 pixel on the enlarged or reduced facial images, the second identifying section 6 identifies the positions of the eyes of an image present within the mask M.

As set forth above, the sample images that were learned at the time of the generation of the second reference data E2 are images in which the intercentral distances of both eyes are 9.7, 10, and 10.3 pixels. Therefore, a magnification ratio at the time of the enlargement or reduction of the facial image is 10.3/9.7. The sample images that were learned at the time of the generation of the second referenced at a E2 are also rotated in the range of ±3° on a plane. Therefore, the facial image is rotated 360° at intervals of 6°.

Note that the characteristic quantity calculation section 2 calculates a characteristic quantity C0 at the stages of variations, such as enlargement/reduction and rotation, of the facial image.

In this embodiment, all of the identifying points at all stages of variations of the extracted facial image are added up. In the facial image within the mask M with a size of 30×30 pixels at the stage of a variation whose added value is greatest, a coordinate system is set with the upper left corner as the origin. The positions corresponding to the coordinates (x1, y1) and (x2, y2) of the positions of the eyes in a sample image are calculated and the positions in the photographic image S0 before variations, which correspond to the calculated positions, are identified as the positions of eyes.

When the first identifying section 5 recognizes that a face is included in the photographic image S0, the first output section 7 calculates the distance of both eyes from the positions of both eyes identified by the second identifying section 6; determines a circumscribed frame of the face by estimating the length between the right and left end portions of the face with the center point of both eyes as center, using the positions of both eyes and the distance between both eyes; and cuts out the image within the circumscribed frame and outputs it to the check section 8 as a facial image for checking.

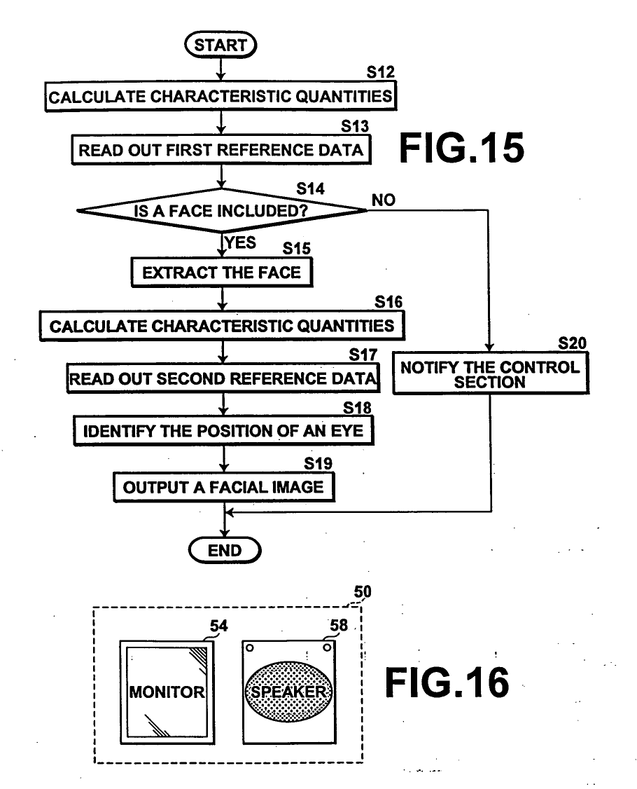

FIG. 15 is a flowchart showing the operation of the face detection section 1 in this embodiment. Initially, the characteristic quantity calculating section 2 calculates the direction and magnitude of a gradient vector K in a photographic image S0 as a characteristic quantity C0 at each of the stages of enlargement/reduction and rotation of the photographic image S0 (S12). Next, the first identifying section 5 reads out the first reference data E1 from the second storage section 4 (S13) and performs first identification of whether a face is included in the photographic image S0 (S14).

If it is judged that a face is included in the photographic image S0 (“Yes” in S14), the first identifying section 5 extracts the face from the photographic image S0 (S15). Note that the first identifying section 5 may extract not only one face but also a plurality of faces. Next, the characteristic quantity calculating section 2 calculates the direction and magnitude of a gradient vector K in the facial image as a characteristic quantity C0 at each of the stages of enlargement/reduction and rotation of the facial image (S16). Next, the second identifying section 6 reads out the second reference data E2 from the second storage section 4 (S17) and performs second identification in which the positions of the eyes in the facial image are identified (S18).

Subsequently, the first output section 7 estimates a circumscribed frame of the face, employing the positions of the eyes identified from the photographic image S0 and the intercentral distance of both eyes calculated based on the positions of the eyes, and cuts out an image within the circumscribed frame and outputs it to the check section 8 as a facial image for checking.

In step S14, if it is judged that no face is included in the photographic image S0 (“No” in step S14), the face detection section 1 notifies the control section 60 of information indicating that no face has been detected (S20) and concludes processing of the photographic image S0.

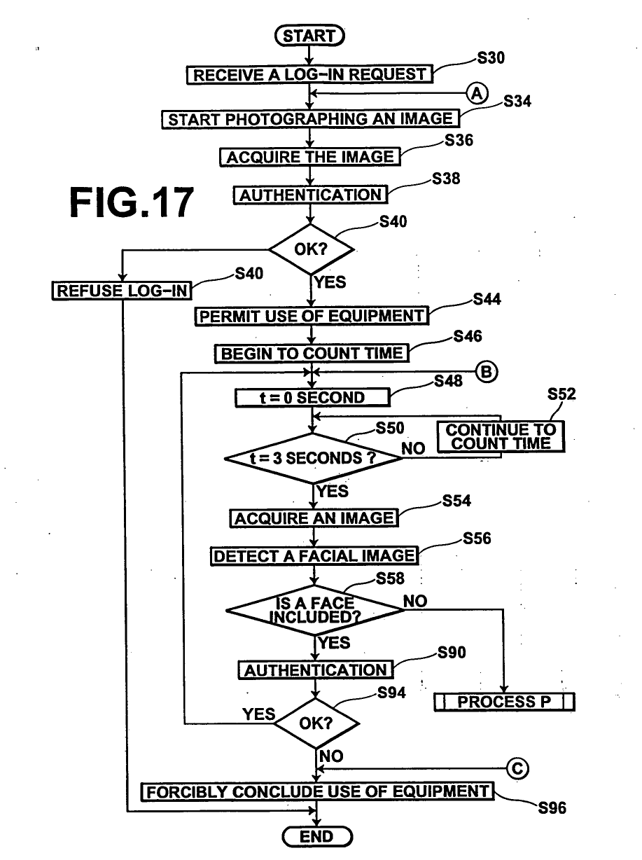

The warning section 50 issues a warning signal according to control of the control section 60. The construction is shown in FIG. 16. As shown in the figure, the warning section 50 is equipped with a monitor 54 and a speaker 58 and issues a warning signal according to a warning instruction (which is to be described in detail later) from the control section 60. More specifically, if a warning instruction is received from the control section 60, the speaker 58 announces that the computer will be locked after 10 seconds. The monitor 54 continues to display on the screen a warning message that the computer will be locked soon, until a warning end signal is received from the control section 60.

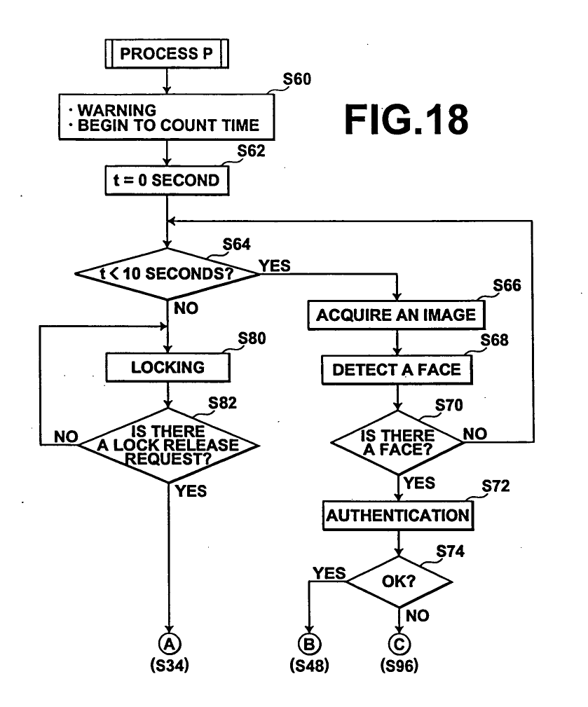

The control section 60 controls operation of each component shown in FIG. 1. The control operation of the control section 60 and operation of each component according to the control of the control section 60 will hereinafter be described with reference to FIGS. 17 and 18.

As shown in FIG. 17, if a user inputs a log-in request through the input section 40 (S30), the control section 60 causes the video camera 20 to start photographing an image and the authentication section 10 to perform authentication that employs both a raw image obtained by the video camera 20 and a registered image stored in the DB 30 (S34, S36, and S38). If the facial image of the raw image does not check with the registered facial image (“No” in S40), the control section 60 refuses the log-in performed by the user (S40). On the other hand, if the facial image of the raw image checks with the registered facial image (“Yes” in S40), the control section 60 permits the log-in performed by the user and begins to count time (S44 and S46). The photographing of an image by the video camera 20 and the counting of time by the control section 60 continue during use of the computer by the user (“No” in S50, and S52). After the lapse of 3 seconds from the start of the time counting, the control section 60 gives an authentication instruction to the authentication section 10 again. In response to the authentication instruction from the control section 60, the authentication section 10 cuts out an image frame from a motion image acquired by the video camera 20 and performs detection of a face (S58). If a face is detected (“Yes” in S58), the authentication section 10 performs authentication, using the detected facial image and a registered image stored in the DB 30, and outputs the result of the authentication to the control section 60 (S90). If the result of the authentication is OK, that is, if the user is identified, the control section 60 resets the counter and performs control so that steps S48 to S90 are repeated (“Yes” in S94, and S48 to S90). On the other hand, if the result of the authentication is NG, that is, if the user is not identified, use of the computer is forcibly concluded (“No” in S94, and S96). In the case of the result of the authentication being NG, in step S64, image acquisition and authentication may be carried out again.

On the other hand, in step S58, if no face is detected (“No” in S58), the control section 60 performs control so that a process P shown in FIG. 18 is performed. As shown in the figure, if the face of the user is not detected, the control section 60 causes the warning section 50 to issue a warning instruction and resets the counter and starts counting time (S60 and S62). If a warning instruction is received from the control section 60, the speaker 58 of the warning section 50 announces that the computer will be locked after 10 seconds. The monitor 54 continues to display on the screen a message that the computer will be locked soon.

In step S58, after the authentication section 10 notifies that no face is detected (“No” in S58), the control section 60 causes the video camera 20 to photograph an image and the authentication section 10 to perform authentication. When the authentication section 10 cannot detect a face from a raw image obtained by the video camera 20 (S66, S68, and “No” in S70), the control section 60 performs control so that steps S66 to S68 are performed. If a face is detected (“Yes” in S70), the control section 60 causes the authentication section 10 to perform checking that employs the detected face (S72). If the result of the authentication is OK, that is, if the user is identified (“Yes” in S74), the control section 60 returns the processing to step S48 shown in FIG. 17 and performs control so that steps S48 to S90 are performed. If the result of the authentication in step S72 is NG, that is, if the qualified user cannot be identified (“No” in S74), the processing advances to step S96 and use of the computer is forcibly concluded (S96).

Step S66 and subsequent steps are carried out when the lapse of time that began in step S62 is less than 10 seconds. When the counter shows 10 seconds (“No” in step S64, that is, when no face is detected after the lapse of 10 seconds), the control section 60 causes the warning section 50 to stop warning display and locks the computer until a lock release request is made (S80, “No” in S82, and S80). If the user inputs a lock release request through the input section 40 during lock, the control section 60 returns to step S34 shown in FIG. 17 and performs control so that step S34 and subsequent steps are carried out (“Yes” in S82, and S34).

Thus, according to the computer of this embodiment of the present invention, during use of the computer by a qualified user, the facial image of the user is continuously obtained, and the obtained facial image is checked with a facial image previously stored in the DB 30. If the obtained facial image does not check with the registered image, use of the computer is forcibly concluded. On the other hand, when the facial image of the user is no longer detected during use of the computer, warning is performed through voice and screen display without forcibly concluding use of the computer immediately, and when the facial image cannot be detected after a predetermined amount of time (e.g., 10 seconds in this embodiment), the computer is locked. If a face is detected within 10 seconds since it could not be detected, authentication is performed using the image of the detected face. If the authentication is OK, continuous use of the computer is permitted. Therefore, even when the face of the qualified user cannot be detected temporarily during use of the computer by bending her head to search for a thing or turning her face transversely to talk with a neighbor, the use of equipment can be prevented from inadvertently being forbidden, if the user returns her face to a detectable position within a predetermined amount of time. In addition, the procedure of unlocking the equipment can be avoided. Thus, the security system of this embodiment can ensure security and is convenient for use.

While the present invention has been described with reference to the preferred embodiment thereof, the invention is not to be limited to the details given herein, but may be modified within the scope of the invention.

For example, in the computer of the embodiment shown in FIG. 1, although the photographic image of the face of a user is used for authentication, other biometric information may be employed according to the type and properties of equipment used. For instance, in the case of mobile telephones, a fingerprint and a palm print, as well as a face, may be employed.

Similarly, in the warning means, it is preferable to issue a warning signal according to the type and properties of equipment used. For instance, in the case of mobile telephones, tactile means such as actuation of a vibrator is better than displaying a warning message on the screen.

In the computer of the embodiment shown in FIG. 1, when a warning instruction is received from the control section 60, the speaker 58 of the warning section 50 announces that the computer will be locked after 10 seconds only once, and the monitor 54 continues to display that the computer will be locked soon, until a warning stop instruction is send out. However, the number of announcements and the displayed content may be changed. For example, with the lapse of time, “The computer will be locked after 10 seconds”, “The computer will be locked after 9 seconds”, . . . may be announced at intervals of 1 second. The monitor 54 may also display character messages of the same content.

Furthermore, the content to be announced may be a user-urging message such as “Please turn your face to the screen of the computer soon”.

In the computer of the embodiment shown in FIG. 1, by registering the facial image of a qualified user in the database beforehand and checking a raw facial image obtained by photographing a user requesting log-in with the registered image, authentication for log-in is performed. However, for example, by distributing an IC card storing the facial image of a qualified user to the user, inserting this ID card into a slot of the computer as the user logs in, reading out the stored facial image from the IC card and storing it in memory, and checking the facial image in the memory with a photographed raw facial image, authentication for log-in may be performed. In the authentication to be performed after log-in (i.e., in the procedure of identifying the qualified user during use), the facial image stored in memory may be employed.

In the computer of the embodiment shown in FIG. 1, authentication for log-in and authentication after log-in are performed in the same method. However, these two authentications do not always need to be the same. For example, by providing a qualified user with an ID number and password, registering the password and the facial image of the user in a database beforehand, inputting the ID number and password as the user logs in, and checking the input ID number and password against the ID number and password stored in the database, authentication for log-in may be performed. The authentication after log-in may be performed by reading out the facial image corresponding to the ID number input by a user from the database and checking this facial image with a photographed raw facial image.

The computer of the embodiment shown in FIG. 1 serves as both equipment to be used by a user and a security system for that equipment. However, the security system of the present invention is not necessarily formed integrally with the equipment that is protected by that security system. For instance, the camera for photographing the facial image of a user is provided in the computer, but the database for storing a registered image, the authentication section, the control section, etc., may be provided in a server connected to the computer.

In the computer of the embodiment shown in FIG. 1, to enhance security, even when a face is detected, use of the computer is forcibly concluded if the result of the authentication is a negative match. In this case, the computer may be locked, as in the case where no face is detected. By doing so, for example, in the case where during use of the computer the user operates it with the assistance of a friend, use of the computer is prevented from being forcibly concluded. This renders the computer convenient for use. In this case, instead of immediately performing forced conclusion or lock, use of the computer may be forcibly concluded or locked after the lapse of a fixed amount of time, and if the facial image of a qualified user is detected within the lapse of the fixed amount of time, continuous use of the computer may be permitted.

In the computer of the embodiment shown in FIG. 1, the video camera 20 comprises a video camera for photographing a motion picture, and the authentication section 10 cuts out an image frame from the motion image obtained by the video camera 20 and uses the image frame in authentication. However, for instance, with the use of a still camera, photography may be performed at the same interval as the time interval at which an image frame is cut out. In this case, instead of cutting out an image frame, the authentication section 10 may use a photographic image obtained directly by a still camera.

In the computer of the embodiment shown in FIG. 1, during use of the computer, photography (cutting-out of an image frame) and authentication are performed, for example, at intervals of 3 seconds. This interval is not limited to 3 seconds, but may be any interval longer than 0 second. However, from the viewpoint of enhancing security, it is preferable that it be less than 1 minute. This interval may also be changed or set by a qualified user or supervisor.

Likewise, the time from when a face is no longer detected to when use of the computer is locked is not limited to 10 seconds. This interval may be changed according to the circumstances under which the security system is used, or may be set by a qualified user or supervisor.

In the computer of the embodiment shown in FIG. 1, an image frame is cut out at the applied timing from a motion image acquired by the video camera, and authentication is performed. However, for example, by generating an average image of image frames obtained before and after the applied timing, this average image may be employed in authentication. By doing so, a reduction in authentication accuracy resulting from changes in expression of a face and conditions of illumination can be prevented.

By cutting out a plurality of image frames before and/or after the applied timing, and performing authentication by use of each of the image frames, authentication whose result is best may be employed.

In performing authentication, instead of determining with a single attempt to authenticate, a plurality of attempts to acquire a facial image and a plurality of attempts to perform checking by use of the facial images may be performed, and if authentication is successful even once, use of the computer may be permitted.

The number of attempts to authenticate, as well as the time to locking and the time interval at which authentication is performed, may be set by a qualified user or supervisor.

By registering a plurality of combinations of the aforementioned various settings, they may be selected.

The interval at which authentication after log-in is performed is not to be fixed. For example, immediately after the first authentication, the next authentication may be performed.

In the case of performing authentication by use of a facial image, accuracy of authentication is reduced when an image other than a face looking straight ahead is employed. To prevent incorrect authentication, for example, when a user does not look straight ahead, the direction of a raw facial image acquired may be estimated. And in the case where it is judged that the face of a user does not look straight ahead, for example, in the case where the distance between both eyes of a detected facial image is impossibly small, the facial image is not employed in authentication and announcement may be performed so that the user looks straight ahead. And by acquiring a facial image looking straight ahead, it may be employed in authentication. In this case, it is necessary to put an upper limit (e.g., 3 times) on the number of times that authentication can be performed again.

In systems where authentication is performed by cutting out an image frame from a motion image, when an image frame to be cut out is not a facial image looking straight ahead, the directions of image frames before or after that image may be detected, and between the two image frames, the facial image looking straight ahead may be employed in authentication.

In systems where authentication and control are performed by a server, a facial authentication log, a user's log-in log, and an operation log may be stored in the server. In the case where the supervisor of a server accesses these logs stored in a predetermined computer, it is preferable to notify pertinent users that these logs have been accessed. By doing so, an abuse of access to logs, and leakage of information regarding operations and other logs, can be prevented. In addition, in giving notification to users, the facial image of a reader may be obtained and transmitted at the same time.

In the case where a plurality of authentication engines are required for a plurality of kinds of ID cards and different methods of modeling facial images stored in the ID cards, authentication may be performed by preparing a plurality of authentication engines and selecting an appropriate authentication engine from the authentication engines. When all of the required authentication engines cannot be mounted in a local environment (e.g., the computer of the embodiment shown in FIG. 1), only the authentication engine whose activity ratio is highest may be mounted in the local environment and a plurality of authentication engines may be mounted in the server. When authentication can be performed with the authentication engine mounted in the local environment, authentication may be performed with the authentication engine mounted in the local environment. On the other hand, when authentication cannot be performed with the authentication engine mounted in the local environment, authentication may be performed in the server by transmitting acquired biometric information to the server.

In the above-described embodiment, the biometric information acquisition means employs the video camera 20 for acquiring a user's facial image, and even after the failure of the acquisition of the facial image, the video camera 20 attempts to continuously acquire the facial image as biometric information. However, the biometric information acquisition means, in addition to the video camera 20, may employ readers, such as a fingerprint reader, a vein reader, an iris reader, etc., which read and acquire the fingerprint information, vein information, iris information, etc., of the user. Before the failure of the facial image acquisition, the facial image may be acquired as biometric information and authenticated. Between the failure of the facial image acquisition and a predetermined amount of time, the fingerprint information, vein information, iris information, etc., may be acquired as biometric information and authenticated. Since the fingerprint information, vein information, iris information, etc., can be acquired and checked more reliably compared with the facial image, the possibility of being able to avoid inadvertent locking of the computer becomes high.

When the facial image cannot be acquired within a predetermined amount of time, or when the authentication is NG, the control section 60 locks the computer to forbid the use of it. However, the control means 60 may be constructed such that, when forbidding use of the equipment, the predetermined amount of time (from the failure of the facial image acquisition to locking of the computer) in subsequent use of the equipment is prolonged or shortened. For instance, the control means 60 can be constructed so that, when the computer is locked once, the predetermined amount of time is made shorter to attain a higher level of security.

What is claimed is:

1. A security system comprising:
biometric information acquisition means that, as equipment is used by a user having qualifications to use said equipment, continuously acquires biometric information of said user;
check means for continuously checking said biometric information against previously registered biometric information of said user;
control means for forbidding continuous use of said equipment when the checking fails; and
warning means for issuing warning to said user when the acquisition of said biometric information of said user by said biometric information acquisition means fails;
wherein said biometric information acquisition means continues to acquire said biometric information of said user even after the failure of the acquisition of said biometric information of said user;
and wherein said control means forbids use of said equipment when said biometric information acquisition means cannot acquire said biometric information of said user in a predetermined amount of time from the failure of the acquisition of said biometric information.

2. The security system as set forth in claim 1, wherein said warning means issues said warning aurally, and/or visually, and/or tactually.

3. The security system as set forth in claim 1, wherein said warning shows said predetermined amount of time.

4. The security system as set forth in claim 2, wherein said warning shows said predetermined amount of time.

5. The security system as set forth in claim 1, wherein said biometric information is a facial image of said user and said biometric information acquisition means comprises image photographing means.

6. The security system as set forth in claim 1, wherein
said biometric information acquisition means comprises image photographing means and at least one of among fingerprint reading means, vein reading means, and iris reading means;
before the failure of the acquisition of said biometric information, said biometric information is the facial image of said user photographed by said photographing means; and
between said acquisition failure and said predetermined amount of time, said biometric information is at least one of among the fingerprint information, vein information, and iris information of said user respectively read by said fingerprint reading means, vein reading means, and iris reading means.

7. The security system as set forth in claim 3, wherein
said biometric information acquisition means comprises image photographing means and at least one of among fingerprint reading means, vein reading means, and iris reading means;
before the failure of the acquisition of said biometric information, said biometric information is the facial image of said user photographed by said photographing means; and
between said acquisition failure and said predetermined amount of time, said biometric information is at least one of among the fingerprint information, vein information, and iris information of said user respectively read by said fingerprint reading means, vein reading means, and iris reading means.

8. The security system as set forth in claim 1, wherein said control means is constructed such that, when forbidding use of said equipment, said predetermined amount of time in subsequent use of said equipment is prolonged or shortened.

9. The security system as set forth in claim 3, wherein said control means is constructed such that, when forbidding use of said equipment, said predetermined amount of time in subsequent use of said equipment is prolonged or shortened.

10. The security system as set forth in claim 4, wherein said control means is constructed such that, when forbidding use of said equipment, said predetermined amount of time in subsequent use of said equipment is prolonged or shortened.

11. The security system as set forth in claim 5, wherein said control means is constructed such that, when forbidding use of said equipment, said predetermined amount of time in subsequent use of said equipment is prolonged or shortened.
